(19) United States
(12) Patent Application Publication
(10) Pub. No.: US 2026/0154002 A1
(43) Pub. Date: Jun. 4, 2026

(54) CONTROLLER FOR PERFORMING PERMANENT DATA ERASE OPERATION AND OPERATING METHOD THEREOF

(71) Applicant: SK hynix Inc., Icheon-si (KR)

(72) Inventors: Byoung Min JIN, Icheon-si (KR); Ku Ik KWON, Icheon-si (KR); Gyu Yeul HONG, Icheon-si (KR)

(21) Appl. No.: 19/297,488

(22) Filed: Aug. 12, 2025

(30) Foreign Application Priority Data
Dec. 4, 2024 (KR) 10-2024-0178595

(51) Int. Cl. G06F 3/06

(52) U.S. Cl. CPC G06F 3/0623; G06F 3/0652; G06F 3/0679

(57) ABSTRACT

Semiconductor devices, controllers, and their operating methods are disclosed. In an embodiment, a controller includes an internal command generator configured to generate overwrite operation setting information in response to a data permanent erase request to perform an overwrite operation on a data storage area corresponding to the data permanent erase request; an overwrite data generator configured to generate a plurality of unit addresses corresponding to the data storage area based on the overwrite operation setting information, and to generate a plurality of pieces of overwrite data to be written to the data storage area corresponding to the plurality of unit addresses, respectively; and a storage area controller configured to control the data storage area to store the plurality of pieces of overwrite data corresponding to the plurality of unit addresses, respectively.

### CROSS-REFERENCE TO RELATED APPLICATION

This patent document claims the priority and benefits of Korean patent application number 10-2024-0178595, filed on Dec. 4, 2024, the entire disclosure of which is incorporated herein by reference as part of the disclosure of this patent document.

### TECHNICAL FIELD

Various embodiments of the disclosed technology generally relate to a semiconductor device, a controller, permanent data erase operation and a method of operating the controller.

### BACKGROUND

A storage device is a component that stores data under the control of a host device, such as a computer, smartphone, tablet, or other electronic devices. A storage device may include a memory device for storing data and a controller that controls the memory device.

### SUMMARY

Various embodiments of the disclosed technology relate to a controller designed to reduce the time required for a permanent data erase operation and a method of operating the controller.

In an embodiment of the disclosed technology, a controller may include an internal command generator configured to generate overwrite operation setting information in response to a data permanent erase request to perform an overwrite operation on a data storage area corresponding to the data permanent erase request; an overwrite data generator in communication with the internal command generator and configured to generate a plurality of unit addresses corresponding to the data storage area based on the overwrite operation setting information, and to generate a plurality of pieces of overwrite data to be written to the data storage area corresponding to the plurality of unit addresses, respectively; and a storage area controller in communication with the overwrite data generator and configured to control the data storage area to store the plurality of pieces of overwrite data corresponding to the plurality of unit addresses, respectively.

In an embodiment of the disclosed technology, a method of operating a controller may include receiving, by the controller, from an external device, a data permanent erase request for deleting data stored in a data storage area; setting range information of the data storage area corresponding to the data permanent erase request and a data pattern to be written to the data storage area; generating an encrypted data pattern by encrypting the data pattern based on the range information; and performing a permanent data erase operation corresponding to the data permanent erase request based on the encrypted data pattern.

In an embodiment of the disclosed technology, a storage device may include a memory device including a plurality of namespaces; a host interface in communication with a memory device and configured to generate overwrite operation setting information for each of the plurality of namespaces in response to a data permanent erase request; and a processor in communication with the host interface and configured to: receive, from the host interface, the overwrite operation setting information for each of the plurality of namespaces; generate overwrite data to be written to each of the plurality of namespaces based on the overwrite operation setting information for each of the plurality of namespaces; and write the overwrite data to the memory device to store the overwrite data in each of the plurality of namespaces.

### BRIEF DESCRIPTION OF THE DRAWINGS

FIG. 1 is a diagram illustrating a storage device based on an embodiment of the disclosed technology.

FIG. 2 is a diagram illustrating an example of performing a permanent data erase operation based on an embodiment of the disclosed technology.

FIG. 3 is a diagram illustrating an example of generating overwrite data based on an embodiment of the disclosed technology.

FIG. 4 is a diagram illustrating another example of generating overwrite data based on an embodiment of the disclosed technology.

FIG. 5 is a diagram illustrating another example of generating overwrite data based on an embodiment of the disclosed technology.

FIG. 6 is a diagram illustrating a method of operating a controller based on an embodiment of the disclosed technology.

FIG. 7 is a diagram illustrating a controller based on an embodiment of the disclosed technology.

### DETAILED DESCRIPTION

Specific structural and functional features of the disclosed technology are disclosed in the context of the following embodiments of the disclosure. However, embodiments of the disclosed technology may be implemented in various forms and should not be construed as being limited to the specific embodiments set forth herein.

A storage device may perform a sanitize operation at the request of the host device. A sanitize operation permanently deletes data by removing user data from a target area of a memory device in the storage device and overwriting it with a predetermined data pattern (e.g., writing the predetermined data pattern to the target area). Through the sanitize operation, the storage device may prevent access to the previously stored user data.

During the sanitize operation, the data pattern used may be encrypted and stored by a predetermined encryption technique. In this case, the time required for the sanitize operation may increase due to repeated requests to encrypt the data pattern and repeated responses to the requests. The disclosed technology can be implemented in some embodiments to reduce the time required for the sanitize operation.

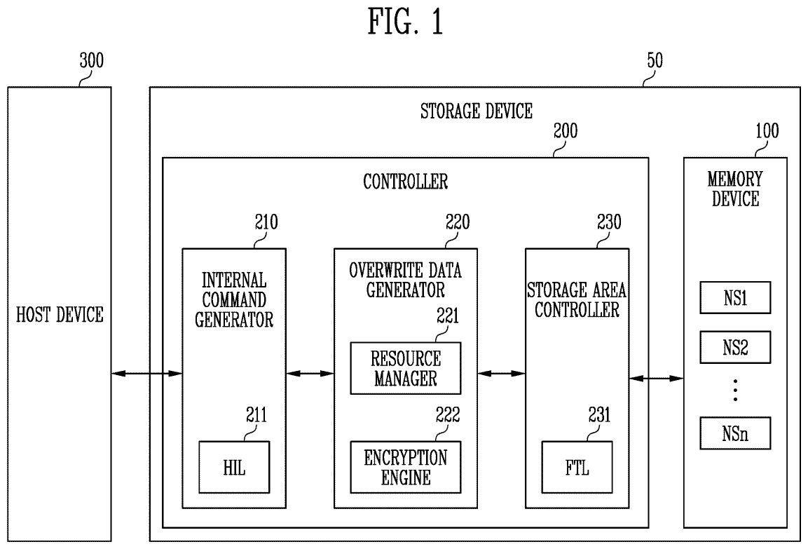

FIG. 1 is a diagram illustrating a storage device 50 based on an embodiment of the disclosed technology. In some embodiments, the term “storage device” is used to indicate a data storage device.

Referring to FIG. 1, the storage device 50 may include a memory device 100 and a controller 200 that controls the memory device 100. The storage device 50 can store data under the control of a host device 300 (or in response to its request), such as a mobile phone, smartphone, MP3 player, laptop computer, desktop computer, gaming machine, television, tablet PC, in-vehicle infotainment system, or others.

In some implementations, the storage device 50 may be configured as one of various types of storage devices depending on the communication method with the host device 300. These types may include a solid-state drive (SSD), a multimedia card in the form of a multimedia card (MMC), an embedded MMC (eMMC), a Reduced-Size MMC (RS-MMC), and a micro-MMC, a secure digital card in the form of a secure digital (SD) card, a mini-SD card, and a micro-SD card, a Universal Serial Bus (USB) storage device, a Universal Flash Storage (UFS) device, a Personal Computer Memory Card International Association (PCMCIA) card type storage device, a peripheral component interconnect (PCI) card type storage device, a PCI Express (PCI-e) card type storage device, a compact flash (CF) card, a smart media card, and a memory stick.

The storage device 50 may be manufactured in various package types, such as a package on package (POP), a system in package (SIP), a system on chip (SOC), a multi-chip package (MCP), a chip on board (COB), a wafer-level fabricated package (WFP), and a wafer-level stack package (WSP).

The memory device 100 may store data. The memory device 100 may operate in response to control signals of the controller 200. The memory device 100 may include a plurality of memory blocks storing data. Each memory block may include a plurality of memory cells. Each of the plurality of memory cells may be configured as a multi-level cell (MLC), which stores two bits of data, a triple-level cell (TLC), which stores three bits of data, a quad-level cell (QLC), which stores four bits of data, or similar configurations.

In an embodiment, the memory device 100 may be a non-volatile memory device, which retains data even when power is not supplied. For ease of description, it is assumed that the memory device 100 is a NAND flash memory device.

In an embodiment, the memory device 100 may receive a command and an address from the controller 200. The memory device 100 may perform an operation specified by the command on the area indicated by the address. For example, the memory device 100 may perform a write operation (or program operation), a read operation, and an erase operation.

In an embodiment, the memory device 100 may include a plurality of namespaces NS1 to NSn. A namespace may refer to an area of a storage space in the memory device 100, divided or partitioned based on a logical block address LBA. In some embodiments, the terms “logical block address LBA,” and “logical address” may be used interchangeably. For example, if the total addresses of the storage space of the memory device 100 range from logical address 1 to logical address 1000), namespace 0 may be an area corresponding to logical address 1 through logical address 500 and namespace 1 may be an area corresponding to logical address 501 through logical address 1000. In some implementations, the term “namespace” can be used to indicate a logical partition or a quantity of memory formatted into logical blocks, allowing for the creation of multiple virtual drives on a single data storage device.

The controller 200 may control the overall operation of the storage device 50.

When power is applied to the storage device 50, the controller 200 may execute firmware. For example, the firmware (FW) may include a Host Interface Layer (HIL) 211, which controls communication with the host device 300, a Flash Translation Layer (FTL) 231, which controls communication between the host device 300 and the memory device 100, and a Flash Interface Layer (FIL), which controls communication with the memory device 100.

In an embodiment, the controller 200 may receive data and a logical block address from the host device 300 and convert the logical block address into a physical block address PBA, which represents an address of each of memory cells in the memory device 100 where data is to be stored. In some embodiments, the terms “physical block address PBA” and “physical address” may be used interchangeably.

In an embodiment, the controller 200 may provide a command, an address, or data corresponding to an operation to the memory device 100 to perform a program operation, a read operation, an erase operation, or others, at the request of the host device 300.

In an embodiment, when the controller 200 receives a write command and a plurality of pieces of data from the host device 300, the controller 200 generates at least one data set based on the logical addresses of the plurality of pieces of data. Metadata included in the data set may include identification information of a namespace in which the pieces of data included in the data set are to be stored. The controller 200 may control the memory device 100 to program or write each data set separately for each namespace based on the metadata included in the data set.

In an embodiment, the controller 200 may independently generate commands, addresses, and data without requests from the host device 300, and transfer the generated commands, addresses, and data to the memory device 100. For example, the controller 200 may provide commands, addresses, and data to the memory device 100 to perform a program operation and a read operation that involve internal operations, such as a wear leveling operation, a read reclaim operation, a garbage collection operation, or others.

In an embodiment, the controller 200 may include an internal command generator 210, an overwrite data generator 220, and a storage area controller 230. The overwrite data generator 220 and the storage area controller 230 may be implemented using hardware including one or more processors, memory, interfaces, or other components to execute assigned operations, software including commands, codes, or other instructions to execute assigned operations, or a combination thereof.

In an embodiment, the internal command generator 210 may control communication between the host device 300 and the controller 200. For example, the internal command generator 210 may drive the HIL 211.

In an embodiment, the controller 200 may receive requests instructing various operations from the host device 300 via the internal command generator 210. In addition, the controller 200 may transmit responses to the requests to the host device 300 via the internal command generator 210.

In an embodiment, the internal command generator 210 may receive a data permanent erase request from the host device 300. The data permanent erase request may represent a request for a sanitize operation in the memory device 100. The sanitize operation may be a permanent data erase operation for deleting data stored in a data storage area in the memory device 100 requested by the host device 300 and storing overwrite data in the requested data storage area. In other words, the sanitize operation may include an erase operation for deleting the data stored in the data storage area and a write operation for storing the overwrite data. The overwrite data may be written to the data storage area based on the permanent data erase operation.

In an embodiment, the data storage area may be an area which stores data, such as a page, memory block, plane, die, namespace, or the like including a plurality of memory cells.

In an embodiment, the data permanent erase request may include identification information of a data storage area of the memory device 100 in which the permanent data erase operation corresponding to the data permanent erase request is to be performed, an address of the data storage area, a data pattern to be written to the data storage area, inversion operation condition information of the data pattern, the number of iterations of the permanent data erase operation, and others. In some embodiments, the term “inversion operation condition information of the data pattern” refers to condition information for performing an inversion operation on the data pattern.

An inversion operation of the data pattern may refer to an operation that inverts the bits included in the data pattern. For example, the inversion operation of the data pattern may include inverting a bit value of ‘1’ included in the data pattern to a bit value of ‘0,’ and a bit value of ‘0’ to a bit value of ‘1.’

In an embodiment, the internal command generator 210 may generate overwrite operation setting information in response to the data permanent erase request provided the host device 300 to perform an overwrite operation on a data storage area in the memory device 100 corresponding to the data permanent erase request. For example, the overwrite operation setting information may include at least one of information such as identification information of the data storage area of the in the memory device 100 in which the permanent data erase operation is to be performed, an address of the data storage area, a data pattern to be written to the data storage area, inversion operation condition information of the data pattern, a number of iterations of the permanent data erase operation, and the like.

In an embodiment, the overwrite operation setting information may include various types of information used to generate overwrite data to be written to the data storage area.

In an embodiment, the overwrite data generator 220 may include a resource manager 221 and an encryption engine 222. The resource manager 221 may be a component for managing a resource such as a write buffer, a read buffer, and the like used to perform a write operation, a read operation, an erase operation, a permanent data erase operation, and other operations. The encryption engine 222 may be a component for encrypting data to be written to the memory device 100 based on various encryption techniques. The resource manager 221 and the encryption engine 222 may be implemented using hardware including one or more processors, memory, interfaces, or other components to execute assigned operations, software including commands, codes, or other instructions to execute assigned operations, or a combination thereof.

In an embodiment, the overwrite data generator 220 may generate a plurality of unit addresses corresponding to the data storage area in the memory device 100 based on the overwrite operation setting information, and generate a plurality of pieces of overwrite data to be written to the plurality of unit addresses, respectively. The unit addresses may be addresses representing data storage areas, such as pages, memory blocks, planes, dies, namespaces, or addresses representing Direct Memory Access (DMA) units, and other data storage units. For example, the overwrite data generator 220 may determine a data pattern based on the overwrite operation setting information, and perform an encryption operation on the determined data pattern to generate the plurality of pieces of overwrite data. In some implementations, the overwrite data generator 220 may determine whether to perform an inversion operation on the data pattern before the encryption operation.

In an embodiment, the storage area controller 230 may control the memory device 100.

In an embodiment, the storage area controller 230 may control the permanent data erase operation on the data storage area in the memory device 100 in response to a request from the overwrite data generator 220. For example, the storage area controller 230 may control the data storage area to store a plurality of pieces of overwrite data corresponding to the plurality of unit addresses, respectively. The storage area controller 230 may drive the FTL 231. The storage area controller 230 may translate a logical address of the host device 300 to a physical address and generate a command corresponding to a request from the host device 300. The storage area controller 230 may provide a command, and an address or data to the memory device 100, or receive data read from the memory device 100.

The host device 300 may communicate with the storage device 50 using at least one of various communication methods such as Universal Serial Bus (USB), Serial AT Attachment (SATA), Serial Attached SCSI (SAS), High Speed Interchip (HSIC), Small Computer System Interface (SCSI), Peripheral Component Interconnect (PCI), PCI express (PCIe), NonVolatile Memory express (NVMe), Universal Flash Storage (UFS), Secure Digital (SD), MultiMedia Card (MMC), embedded MMC (eMMC), Dual In-line Memory Module (DIMM), Registered DIMM (RDIMM), and Load Reduced DIMM (LRDIMM) communication methods.

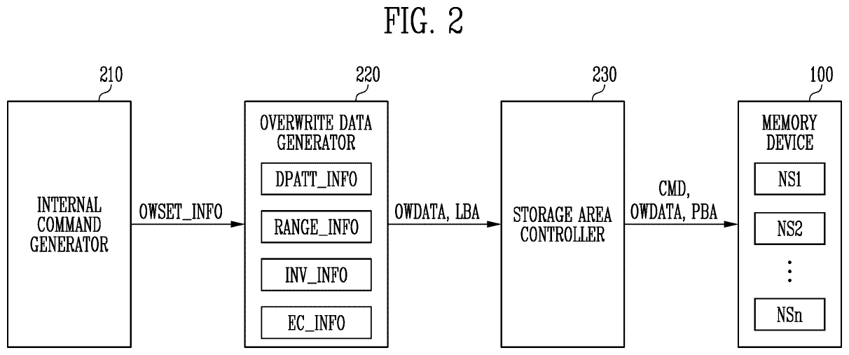

FIG. 2 is a diagram illustrating an example of performing a permanent data erase operation based on an embodiment of the disclosed technology.

Referring to FIG. 2, the internal command generator 210 may request the overwrite data generator 220 to generate overwrite data OWDATA, providing overwrite operation setting information OWSET_INFO.

The overwrite data generator 220 may receive the overwrite operation setting information OWSET_INFO from the internal command generator 210.

In an embodiment, the overwrite data generator 220 may store the overwrite operation setting information OWSET_INFO. For example, the overwrite data generator 220 may store information such as information on a data pattern DPATT_INFO to be written to a data storage area, sanitization range information RANGE_INFO which indicates identification information of the data storage area on which a permanent data erase operation is to be performed and an address of the data storage area, inversion operation condition information INV_INFO of the data pattern, the number of iterations of the permanent data erase operation, and the like.

In an embodiment, the data pattern, the inversion operation condition information INV_INFO of the data pattern, and the number of iterations of the permanent data erase operation may vary depending on the data storage area. For example, the permanent data erase operation may be performed on each of the plurality of namespaces NS1 to NSn based on a different data pattern. Also, the permanent data erase operation may be performed on each of the plurality of namespaces NS1 to NSn based on different inversion operation condition information INV_INFO. In some implementations, the permanent data erase operation may be performed on each of the plurality of namespaces NS1 to NSn based on a different number of iterations.

In an embodiment, identification information for the plurality of namespaces NS1 to NSn may be different from each other.

In addition, the overwrite data generator 220 may store information related to the encryption operation EC_INFO. The information related to the encryption operation EC_INFO may include an encryption technique and the size of data on which the encryption operation is performed.

In an embodiment, the overwrite data generator 220 may generate the overwrite data OWDATA based on the information on the data pattern DPATT_INFO, the sanitization range information RANGE_INFO, the inversion operation condition information INV_INFO of the data pattern, and the information related to the encryption operation EC_INFO.

In an embodiment, the storage area controller 230 may receive the overwrite data OWDATA and the logical address LBA of the data storage area from the overwrite data generator 220, and may control the data storage area to store the overwrite data OWDATA in the data storage area indicated by the logical address LBA.

For example, the storage area controller 230 may translate the logical address LBA to the physical address PBA mapped to the logical address LBA. The storage area controller 230 may generate a command CMD instructing the permanent data erase operation and provide the generated command CMD, the overwrite data OWDATA, and the physical address PBA to the memory device 100. The command CMD may instruct both (1) an erase operation for erasing data in the data storage area, and (2) a write operation for storing the overwrite data OWDATA in the data storage area from which the data is erased in response to the command CMD instructing the permanent data erase operation.

The memory device 100 may perform the permanent data erase operation on the data storage area indicated by the physical address PBA based on the command CMD and the overwrite data OWDATA provided from the storage area controller 230.

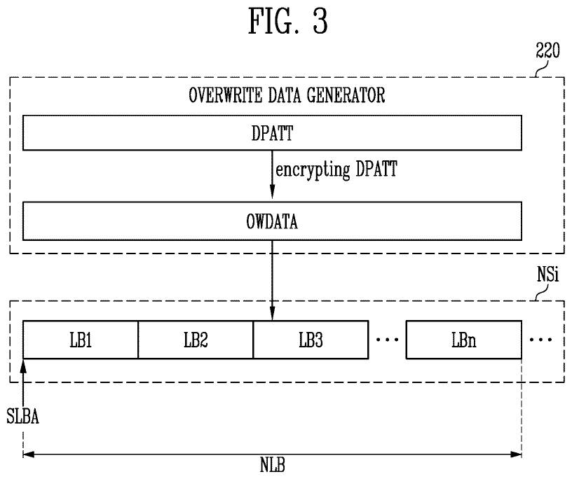

FIG. 3 is a diagram illustrating an example of generating the overwrite data OWDATA based on an embodiment of the disclosed technology. Specifically, FIG. 3 illustrates an example that one or more logical memory blocks LB1 to LBn included in the ith namespace NSi of the plurality of namespaces NS1to NSn is a target data storage area for the permanent data erase operation. However, unlike the example illustrated in FIG. 3, a target data storage area may include all logical memory blocks included in a single namespace, or a plurality of logical memory blocks included in a plurality of namespaces.

Referring to FIG. 3, the ith namespace NSi may include the plurality of logical memory blocks LB1 to LBn. The plurality of logical memory blocks LB1 to LBn may be arranged with consecutive logical addresses.

In an embodiment, the logical address of the data storage area may include a start address SLBA of the data storage area and the number of logical memory blocks NLB. For example, the sanitization range information RANGE_INFO stored in the overwrite data generator 220 may include identification information of the ith namespace NSi, the start address SLBA indicating the first logical memory block LB1, and the number of logical memory blocks NLB indicating n logical memory blocks from the start address SLBA.

In an embodiment, the overwrite data generator 220 may generate the overwrite data OWDATA by encrypting a data pattern DPATT. For example, the overwrite data generator 220 may encrypt the data pattern DPATT corresponding to the ith namespace NSi to generate the overwrite data OWDATA to be written to the plurality of logical memory blocks LB1 to LBn.

In an embodiment, the overwrite data generator 220 may encrypt the data pattern DPATT using at least one of the identification information of the data storage area or the logical address of the data storage area as seed data. For example, the overwrite data generator 220 may encrypt the data pattern DPATT corresponding to the ith namespace NSi using the identification information of the ith namespace NSi and the start address SLBA indicating the first logical memory block LB1 as seed data.

The overwrite data OWDATA may be written to physical memory blocks corresponding to the plurality of logical memory blocks LB1 to LBn, e.g., memory blocks in the memory device 100, under the control of the storage area controller 230.

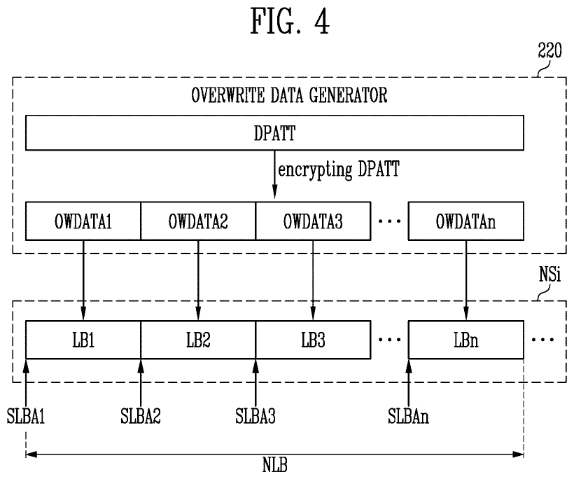

FIG. 4 is a diagram illustrating another example of generating overwrite data based on an embodiment of the disclosed technology.

Referring to FIG. 4, the overwrite data generator 220 may encrypt the data pattern DPATT for each preset size.

In an embodiment, the overwrite data generator 220 may check a preset size from the information related to the encryption operation EC_INFO. The preset size may be the size of one data storage area, such as a page, memory block, plane, die, or the like, or may represent a Direct Memory Access (DMA) unit size, or the like.

For example, it is assumed that the DMA unit size corresponds to the size of a logical memory block, and the overwrite data generator 220 encrypts the data pattern DPATT for each DMA unit size. Specifically, the overwrite data generator 220 may encrypt the data pattern DPATT using the identification information of the ith namespace NSi and a start address SLBA1 of the first logical memory block LB1 as seed data to generate first overwrite data OWDATA1 to be written to the first logical memory block LB1. The overwrite data generator 220 may encrypt the data pattern DPATT using the identification information of the ith namespace NSi and a start address SLBA2 of the second logical memory block LB2 as seed data to generate second overwrite data OWDATA2 to be written to the second logical memory block LB2. The overwrite data generator 220 may encrypt the data pattern DPATT using the identification information of the ith namespace NSi and a start address SLBA3 of the third logical memory block LB3 as seed data to generate third overwrite data OWDATA3 to be written to the third logical memory block LB3. The overwrite data generator 220 may encrypt the data pattern DPATT using the identification information of the ith namespace NSi and a start address SLBAn of the nth logical memory block LBn as seed data to generate nth overwrite data OWDATAn to be written to the nth logical memory block LBn.

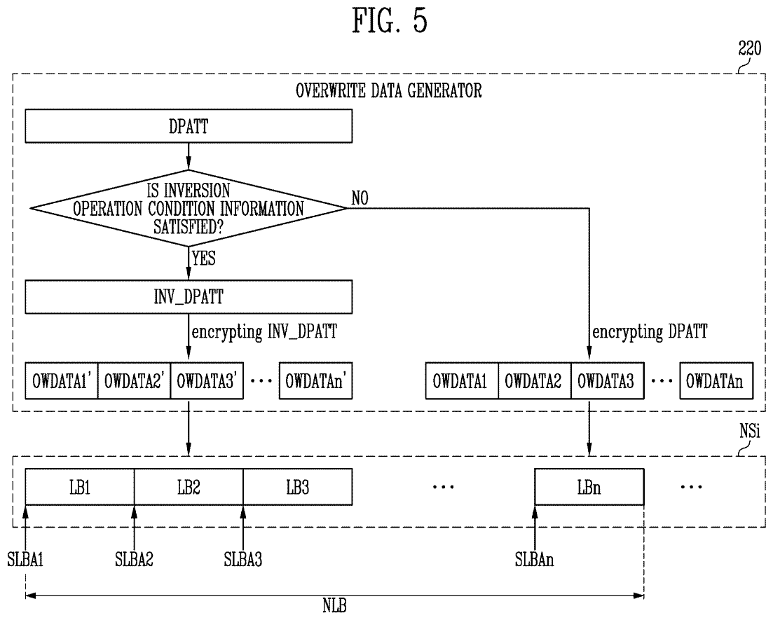

FIG. 5 is a diagram illustrating another example of generating overwrite data based on an embodiment of the disclosed technology.

Referring to FIG. 5, the overwrite data generator 220 may determine whether to invert the data pattern DPATT based on the inversion operation condition information. The overwrite data generator 220 may invert the data pattern DPATT when the inversion operation condition information is satisfied, and may use the data pattern DPATT without inverting the data pattern DPATT when the inversion operation condition information is not satisfied. The inversion operation condition information may be a condition determined by the number of iterations of the permanent data erase operation, a predetermined size of the data storage area, or the like.

In an embodiment, the overwrite data generator 220 may be determined based on the number of iterations of the permanent data erase operation. For example, the overwrite data generator 220 may alternate between using the data pattern DPATT and an inverted data pattern INV_DPATT when performing the permanent data erase operation repeatedly based on the number of iterations of the permanent data erase operation, and may generate the overwrite data OWDATA1 to OWDATAn using the data pattern DPATT at the last permanent data erase operation. As another example, the overwrite data generator 220 may generate the overwrite data OWDATA1 to OWDATAn using the data pattern DPATT at the odd-numbered permanent data erase operation, and generate overwrite data OWDATA1′ to OWDATAn′ using the inverted data pattern INV_DPATT at the even-numbered permanent data erase operation.

In an embodiment, the overwrite data generator 220 may alternate between using the data pattern DPATT and the inverted data pattern INV_DPATT for each predetermined size of the data storage area. For example, assuming that the data pattern DPATT and the inverted data pattern INV_DPATT are alternately used for each logical memory block, a data pattern for the first logical memory block LB1 may be used as is, while a data pattern for the second logical memory block LB2 may be inverted.

In the example described above, the data pattern DPATT is inverted based on the number of iterations of the permanent data erase operation and the predetermined size of the data storage area, but the disclosed technology is not necessarily limited thereto, and the overwrite data generator 220 may invert the data pattern DPATT based on various conditions.

In an embodiment, the overwrite data generator 220 may invert the data pattern DPATT based on the inversion operation condition information, and then encrypt the inverted data pattern INV_DPATT to generate the overwrite data OWDATA1′ to OWDATAn′.

In an example where the inverted data pattern INV_DPATT is encrypted per logical memory block, the overwrite data generator 220 may encrypt the inverted data pattern INV_DPATT using the identification information of the ith namespace NSi and the start address SLBA1 of the first logical memory block LB1 as seed data to generate the first overwrite data OWDATA1′ to be written to the first logical memory block LB1. The overwrite data generator 220 may encrypt the inverted data pattern INV_DPATT using the identification information of the ith namespace NSi and the start address SLBA2 of the second logical memory block LB2 as seed data to generate the second overwrite data OWDATA2′ to be written to the second logical memory block LB2. The overwrite data generator 220 may encrypt the inverted data pattern INV_DPATT using the identification information of the ith namespace NSi and the start address SLBA3 of the third logical memory block LB3 as seed data to generate the third′ overwrite data OWDATA3′ to be written to the third logical memory block LB3. The overwrite data generator 220 may encrypt the inverted data pattern INV_DPATT using the identification information of the ith namespace NSi and the start address SLBAn of the nth logical memory block LBn as seed data to generate the nth overwrite data OWDATAn′ to be written to the nth logical memory block LBn.

The method of generating the first to nth overwrite data OWDATA1 to OWDATAn is the same as the method described with reference to FIG. 4; therefore, a detailed description will be omitted.

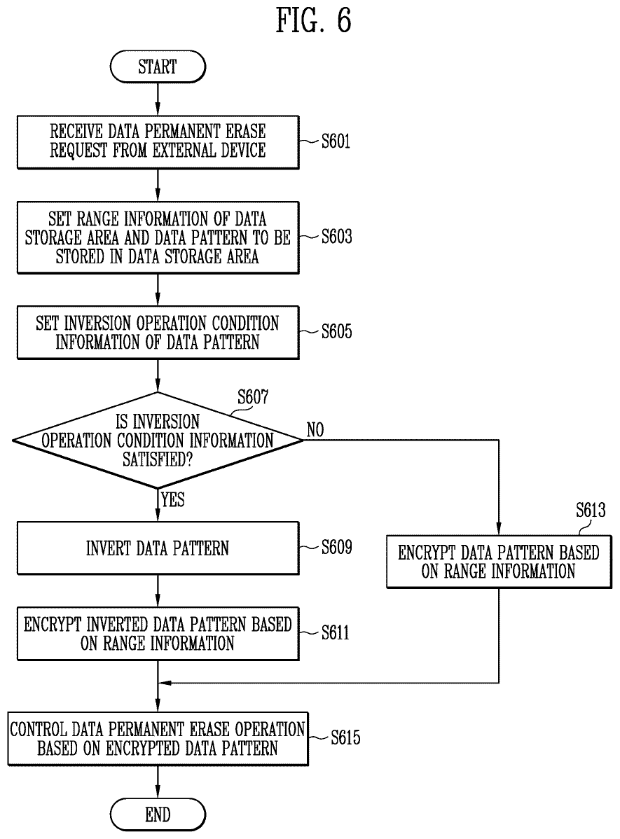

FIG. 6 is a diagram illustrating a method of operating the controller 200 based on an embodiment of the disclosed technology.

The method illustrated in FIG. 6 may be performed by the controller 200 illustrated in FIG. 1.

Referring to FIG. 6, at S601, the controller 200 may receive a data permanent erase request from an external device. The external device may be the host device 300 of FIG. 1.

At S603, the controller 200 may set range information of a data storage area corresponding to the data permanent erase request and a data pattern to be written to the data storage area.

For example, the controller 200 may encrypt the data pattern using the range information as seed data.

At S605, the controller 200 may set inversion operation condition information of the data pattern.

In some implementations, the controller 200 may determine whether to invert the data pattern based on the inversion operation condition information.

For example, at S607, the controller 200 may determine whether the inversion operation condition information is satisfied.

According to the determination result at S607, when the inversion operation condition information is satisfied, the controller 200 may invert the data pattern at step S609.

At S611, the controller 200 may encrypt the inverted data pattern based on the range information.

In contrast, according to the determination result at S607, when the inversion operation condition information is not satisfied, the controller 200 may encrypt the data pattern based on the range information at step S613.

At S615, the controller 200 may control a permanent data erase operation corresponding to the data permanent erase request based on the encrypted data pattern.

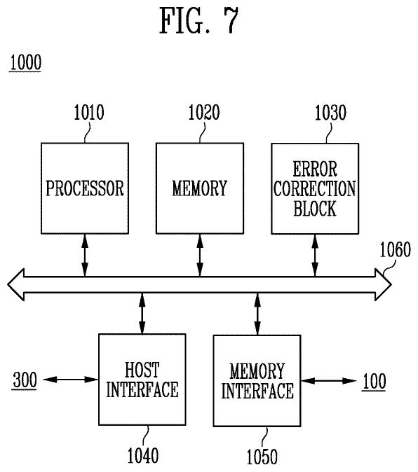

FIG. 7 is a diagram illustrating a controller based on an embodiment of the disclosed technology.

A controller 1000 shown in FIG. 7 may represent the controller 200 shown in FIG. 1.

Referring to FIG. 7, the controller 1000 may include a processor 1010, memory 1020, an error correction circuit 1030, a host interface 1040, a memory interface 1050, and a communication bus 1060. The processor 1010, the memory 1020, the error correction circuit 1030, the host interface 1040, and the memory interface 1050 of the controller 1000 may communicate with each other via the communication bus 1060.

The host interface 1040 shown in FIG. 7 provides an interface with the host device 300 carry communications between the controller 1000 and the host device 200, and may include the internal command generator 210 shown in FIG. 1.

The processor 1010 may execute firmware, code, or one or more commands that include various types of information required for the controller 1000 to operate. In an embodiment, the overwrite data generator 220 and the storage area controller 230 of FIG. 1 may be implemented as one or more components included in the processor 1010.

The memory 1020 may be used as buffer memory, cache memory, operational memory, or other types of memory.

In some implementations, the memory 1020 may store firmware, code, and one or more commands that include various types of information required for the controller 1000 to operate.

The error correction circuit 1030 may perform error correction when storing data in the memory device 100 or when reading data from the memory device 100. For example, the error correction circuit 1030 may perform error correcting code (ECC) encoding based on data to be written to the memory device 100. The encoded data may be transferred to the memory device 100. The error correction circuit 1030 may perform ECC decoding on data received from the memory device 100.

The controller 1000 may communicate with an external device (e.g., the host device 300, an application processor, or the like) via the host interface 1040.

In an embodiment, the host interface 1040 may receive a request from the external device instructing an internal operation of a plurality of data storage areas, and may generate overwrite operation setting information for each of the plurality of data storage areas based on the request. For example, the plurality of data storage areas may represent a plurality of namespaces. The request may specifically instruct the permanent data erase operation.

In an embodiment, the overwrite operation setting information may be different for each of the plurality of namespaces.

In an embodiment, the processor 1010 may determine whether to invert a data pattern to be written to each of the plurality of namespaces based on the inversion operation condition information of the data pattern. The processor 1010 may encrypt the data pattern to be written to each of the plurality of namespaces or the inverted data pattern based on identification information for each of the plurality of namespaces and a logical address of each of the plurality of namespaces to generate overwrite data.

The controller 1000 may communicate with the memory device 100 via the memory interface 1050. The controller 1000 may transmit a command, an address, a control signal, and the like, to the memory device 100 and may receive data from the memory device 100 via the memory interface 1050.

The processor 1010 may transmit a command which instructs the permanent data erase operation, a logical address of each of the plurality of namespaces, and overwrite data to the memory device 100 via the memory interface 1050.

In some embodiments of the disclosed technology, a controller capable of reducing the time required for a permanent data erase operation and a method of operating the controller are provided.

The embodiments and implementations disclosed above are examples only, and thus various enhancements and variations to the disclosed embodiments and implementations and other embodiments and implementations can be made based on what is described and illustrated in this patent document.

What is claimed is:

1. A controller for controlling a memory device that stores data, comprising:
an internal command generator configured to generate overwrite operation setting information in response to a data permanent erase request to perform an overwrite operation on a data storage area of the memory device corresponding to the data permanent erase request;
an overwrite data generator in communication with the internal command generator and configured to generate a plurality of unit addresses corresponding to the data storage area based on the overwrite operation setting information, and to generate a plurality of pieces of overwrite data to be written to the data storage area corresponding to the plurality of unit addresses, respectively; and
a storage area controller in communication with the overwrite data generator and configured to control the data storage area in the memory device to store the plurality of pieces of overwrite data corresponding to the plurality of unit addresses, respectively.

2. The controller of claim 1, wherein the overwrite operation setting information includes at least one of identification information of the data storage area in the memory device, a logical address of the data storage area, information on a data pattern to be written to the data storage area, or inversion operation condition information for performing an inversion operation on the data pattern.

3. The controller of claim 2, wherein the overwrite data generator generates the plurality of pieces of overwrite data by encrypting the data pattern.

4. The controller of claim 3, wherein the overwrite data generator encrypts the data pattern for a preset size.

5. The controller of claim 3, wherein the overwrite data generator encrypts the data pattern by using, as seed data, at least one of the identification information of the data storage area or the logical address of the data storage area.

6. The controller of claim 2, wherein the overwrite data generator determines whether to invert the data pattern based on the inversion operation condition information.

7. The controller of claim 6, wherein, upon inverting, by the overwrite data generator, the data pattern based on the inversion operation condition information, the overwrite data generator encrypts an inverted data pattern to generate the plurality of pieces of overwrite data.

8. The controller of claim 1, wherein the data storage area corresponds to one of a plurality of namespaces.

9. A method of operating a controller for controlling a memory device that stores data, the method comprising:
receiving, by the controller, from an external device, a data permanent erase request for deleting data stored in a data storage area of the memory device;
setting range information of the data storage area corresponding to the data permanent erase request and a data pattern to be written to the data storage area;
generating an encrypted data pattern by encrypting the data pattern based on the range information; and
performing a permanent data erase operation corresponding to the data permanent erase request based on the encrypted data pattern.

10. The method of claim 9, wherein performing the permanent data erase operation corresponding to the data permanent erase request comprises:
deleting the data stored in the data storage area; and
storing the encrypted data pattern in the data storage area from which the data is deleted.

11. The method of claim 9, wherein encrypting the data pattern includes encrypting the data pattern using the range information as seed data.

12. The method of claim 9, wherein encrypting the data pattern includes encrypting the data pattern for a predetermined size.

13. The method of claim 9, further comprising, before encrypting the data pattern:
setting inversion operation condition information for performing an inversion operation on the data pattern; and
determining whether to invert the data pattern based on the inversion operation condition information.

14. The method of claim 13, wherein encrypting the data pattern, in response to inverting the data pattern based on the inversion operation condition information, encrypting an inverted data pattern.

15. A storage device, comprising:
a memory device including a plurality of namespaces associated with local address information;
a host interface in communication with a host device to communicate with the host device for the host device to access the memory device and configured to generate overwrite operation setting information for each of the plurality of namespaces in response to a data permanent erase request from the host device; and
a processor in communication with the host interface and configured to:
receive, from the host interface, the overwrite operation setting information for each of the plurality of namespaces; generate overwrite data to be written to each of the plurality of namespaces based on the overwrite operation setting information for each of the plurality of namespaces; and write the overwrite data to the memory device in each of the plurality of namespaces.

16. The storage device of claim 15, wherein the overwrite operation setting information is different for each of the plurality of namespaces.

17. The storage device of claim 15, wherein the overwrite operation setting information includes at least one of identification information of each of the plurality of namespaces, a logical address of each of the plurality of namespaces, information on a data pattern to be written to each of the plurality of namespaces, and inversion operation condition information for performing an inversion operation on the data pattern.

18. The storage device of claim 17, wherein the processor is configured to:
determine whether to invert the data pattern to be written to each of the plurality of namespaces based on the inversion operation condition information of the data pattern; and encrypt the data pattern to be written to each of the plurality of namespaces, or an inverted data pattern, based on the identification information of each of the plurality of namespaces and the logical address of each of the plurality of namespaces to generate the overwrite data.
